(19) United States
(12) Patent Application Publication
(10) Pub. No.: US 2017/0139678 A1
(43) Pub. Date: May 18, 2017

(54) VERIFICATION PROPERTY INTEGRATION APPARATUS, VERIFICATION PROPERTY INTEGRATION METHOD, AND STORAGE MEDIUM

(71) Applicant: NEC Corporation, Minato-ku, Tokyo (JP)

(72) Inventor: Kazuhiro FUNAKOSHI, Tokyo (JP)

(73) Assignee: NEC Corporation, Minato-ku, Tokyo (JP)

(21) Appl. No.: 15/300,372

(22) PCT Filed: Apr. 6, 2015
(86) PCT No.: PCT/JP2015/001924

§ 371 Date: Sep. 29, 2016

(30) Foreign Application Priority Data
Apr. 17, 2014 (JP) 2014-085270

(51) Int. Cl. G06F 9/44; G06F 11/36

(52) U.S. Cl. CPC G06F 8/10; G06F 11/3608

(57) ABSTRACT

A verification property integration device that enables verification of a product or system integrated by products verified by different formal techniques, such as by formal specification description or model inspection. The apparatus includes a library, a first theorem-proof-assistant description generating unit, and the second theorem-proof-assistant description generating unit. The library is configured to provide definition of semantics of a formal specification description and a model checking description which are to be provided to a theorem-proof-assistant description. The first theorem-proof-assistant description generating unit is configured to translate the formal specification description into a representation on a theorem proof assistant which is defined and to be verified by using the library. The second theorem-proof-assistant description generating unit is configured to translate a model and a temporal logic formula in the model checking description into a representation on the theorem proof assistant which is defined and to be verified by using the library.

### TECHNICAL FIELD

The present invention relates to a verification property integration apparatus, a verification property integration method, and a verification property integration program that enable verification of a product or a system into which products verified by using different formal methods are integrated.

### BACKGROUND ART

For verifying safety of products, formal methods are required by various international standards. Formal methods can be broadly classified into formal specification description, model checking, theorem proving, and the like.

These techniques are used as follows.

Formal specification description is a technique to define behavior of a product formally and to obtain correct behavior by proving mathematically whether the behavior meets a pre-condition, an invariant, or a post-condition, which represents a given specification. In general, the formal specification description starts with description of a small specification that has no possibility of an error and specifications are added while verifying that restrictions are satisfied. Unless an error is included in the operation of adding specifications, correctness of behavior is proved. Hereinafter, a description by the formal specification description will be simply referred to as formal specification description.

Model checking is a technique to describe a state transition model of a product and to search a transition to an in appropriate state through the state transitions in the model. When the transition to an inappropriate state is not found, the model can mathematically ensure safety. Hereinafter, a description using the model checking will be referred to as model checking description.

In theorem proving, intended behavior is mathematically defined. Specifically, in the theorem proving, a desirable property of a given function is derived by using of a mathematically correct operation, thereby proving that the property is satisfied.

As tools that apply techniques classified as formal specification description, VDM (registered trademark of SCSK Corporation) (see NPL1) and Event-B (see NPL2) are known. As tools that apply techniques classified as model checking, SPIN (see NPL3) and UPPAAL (see NPL4) are known. As tools that apply techniques classified as theorem proving, Coq (see NPL5), Isabelle (see NPL6), and PhoX (see NPL7) are known.

PTL1 describes a method for comparing a program with existing programs and combining differences with a similar program. In contrast, in the present invention, objects handled in the present invention do not have similarities. Because the present invention is based on an assumption different from the assumption of the method described in PTL1, the method described in PTL1 is not effective for a problem (which will be described later) to be solved by the present invention.

PTL2 describes a method for taking a program as an input and extracting a state transition diagram of the program. In contrast, in translation of state transitions included in the present invention, inputs and outputs are state transitions themselves, even though being represented in different ways respectively. Accordingly, the method described in PTL2, which extracts a state transition diagram from a program, does not contribute to the present invention.

PTL3 describes a method for automated proving of logic circuits. However, in general, components of a logic circuit and higher-order predicate logics dealt with in the present invention belong to different mathematical classes. Accordingly, the method described in PTL3 cannot be applied to the present invention. In addition, an objective of the present invention is not automation of proving but translation of different formal (mathematical) representations into representations in a theorem proof assistant.

PTL4 describes a technique that deals with translation between program languages. The technique described in PTL4 uses information employed when translating a program into an executable data structure, models the program as a tree structure. The present invention, in contrast, handles formal languages. In addition, most of formal languages cannot be compiled and translated into an executable format. The technique described in PTL4 differs from the technique of the present invention in the method of extracting a meaning from a description.

Techniques relating to formal methods are disclosed in PTL5 and PTL6. PTL5 discloses a technique that uses a plurality of different translation rules to translate a software source code into a checking code described as an input language for a checking tool. The technique disclosed in PTL5 is merely a technique for translating a source code into a format that can be used in model checking. PTL6 discloses a technique for coding an operation of a hybrid system that deals with a continuous value and a discrete value by using a programming language and verifying the code by using a formal method. The technique disclosed in PTL6 merely verifies a code that describes an operation to be verified by using a theorem proving device. Both of the techniques disclosed in PTL5 and PTL6 are inadequate for solving a problem addressed by the present application, which will be described later.

### CITATION LIST

### Patent Literature

[PTL1] Japanese Laid-open Patent Publication No. H5(1993)-53780
[PTL2] Japanese Laid-open Patent Publication No. H8(1996)-202540
[PTL3] Japanese Laid-open Patent Publication No. H9(1997)-325975
[PTL4] Japanese Laid-open Patent Publication No. H10(1998)-508398
[PTL5] Japanese Laid-open Patent Publication No. 2013-120491
[PTL6] Japanese Laid-open Patent Publication No. 2013-003897

### Non-Patent Literature

[NPL1] “VDM Tools Manual”, [online], [retrieved on Apr. 4, 2014], Internet <URL:http://www.vdmtools.jp/>
[NPL2] “Rodin Handbook”, [online], [retrieved on Apr. 4, 2014], Internet <URL:http://handbook.event-b.org>
[NPL3] “Basic Spin Manual”, [online], [retrieved on Apr. 4, 2014], Internet <URL:http://spinroot.com/spin/Man/Manual.html/>
[NPL4] “Formal Methods for Real Time Systems: Automatic Verification & Validation”, Oct. 11, 1998, [online], [retrieved on Apr. 4, 2014], Internet <URL: http://people.cs.aau.dk/˜kg1/ARTES/index.htm>
[NPL5] “The Coq Proof Assistant Reference Manual”, [online], [retrieved on Apr. 4, 2014], Internet <URL: http://coq.inria.fr/distrib/current/refman/>
[NPL6] “Tutorials and manuals for Isabelle”, [online], [retrieved on Apr. 4, 2014], Internet <URL: https://www.cl.cam.ac.uk/research/hvg/Isabelle/documentation.html>
[NPL7] “The PhoX Proof Assistant”, [online], [retrieved on Apr. 4, 2014], Internet <URL: http://www.lama.univ-savoie.fr/˜RAFFALLI/phox.html>

### SUMMARY OF INVENTION

### Technical Problem

Formal method techniques are based on different theories, respectively, and are specialized in different areas. Accordingly, it is common to apply different formal methods for verifying different products.

However, an industrial idea that enables properties verified using these techniques to be handled in other systems has not been conceived. As a scale of product development increases, there is a demand for application for integrating existing products into another product by combining them together. However, when respective existing products are verified applying different formal methods, it is difficult to verify a product or a system into which the existing products are integrated. This is because respective existing products have been verified using different representations on the basis of different theories. For example, formal specification description is based on set theory whereas model checking is based on a temporal logic. Techniques that enable a single system, method, apparatus, system, or program to handle such representations and theories have not been provided.

Because a theorem proof assistant can represent a recursive typed lambda calculus, the theorem proof assistant can represent the set theory and the temporal logics, in principle. However, in the theorem proof assistant, a method for implementing theories that are associated with the representations of the set theory and the temporal logics and a translation method for these theories have not been provided.

A property of a product is a mathematical predicate for a mathematical definition of the product. Accordingly, it is important to translate not only the predicate but also the mathematical definition of the product for verification based on the property.

Therefore, an object of the present invention is to provide a verification property integration apparatus, a verification property integration method, and a verification property integration program that enable verification of a product or a system into which products verified using different formal methods such as formal specification description and model checking are integrated.

That is, a first technical problem addressed by the present invention is to establish a method for representing a formal specification description on a theorem proof assistant and a method for translating the formal specification description. A second technical problem addressed by the present invention is to establish a method for representing a model checking description on a theorem proof assistant and a method for translating the model checking description.

### Solution to Problem

A verification property integration apparatus according to one aspect of the present invention includes, a library for providing definition of semantics of a formal specification description and a model checking description which are to be provided to a theorem-proof-assistant description; first theorem-proof-assistant description generating means for translating the formal specification description into a representation on a theorem proof assistant by using the library; and second theorem-proof-assistant description generating means for translating a model and a temporal logic formula in the model checking description into a representation on the theorem proof assistant by using the library.

A verification property integration method according to another aspect of the present invention includes, translating a property defined and verified using a formal specification description and a model checking description into a description on a theorem proof assistant, by translating the formal specification description into a representation on the theorem proof assistant by using a library which provides definition of semantics of the formal specification description and the model checking description which are to be provided to a theorem proof assistant description, and translating a model and a temporal logic formula in the model checking description into a representation on the theorem proof assistant by using the library.

A verification property integration program according to another aspect of the present invention causes a computer to execute: processing for translating a formal specification description into a representation on a theorem proof assistant by using a library which provides definition of semantics of the formal specification description and a model checking description which are to be provided to a theorem-proof-assistant description; and processing for translating a model and a temporal logic formula in the model checking description into a representation on the theorem proof assistant by using the library. A purpose of the present invention may be achieved by a computer-readable storage medium recorded with the verification property integration program.

### Advantageous Effects of Invention

The present invention enables verification of a product or a system into which products verified using different formal methods such as formal specification description and model checking are integrated.

### BRIEF DESCRIPTION OF DRAWINGS

FIG. 1 is a block diagram illustrating a configuration of a first exemplary embodiment of a verification property integration system according to the present invention.

FIG. 2 is a flowchart illustrating an operation of a first theorem-proof-assistant description generating unit.

FIG. 3 is a flowchart illustrating an operation of a second theorem-proof-assistant description generating unit.

FIG. 4 is a diagram schematically illustrating an interrelationship between a formal specification description and a model checking description before the present invention is carried out.

FIG. 5 is a diagram schematically illustrating an interrelationship between a translated formal specification description and a translated model checking description and a linkage definition after the present invention is carried out.

FIG. 6 is a diagram illustrating an example of a description of “Axioms” before translation.

FIG. 7 is a diagram illustrating an example of a translated description of “Axioms”.

FIG. 8 is a diagram illustrating an example of a description of “Theorems” before translation.

FIG. 9 is a diagram illustrating an example of a translated description of “Theorems”.

FIG. 10 is a diagram illustrating a relationship between extension and refinement of a model in Event-B.

FIG. 11 is a diagram illustrating an example of a description “Machines” before translation.

FIG. 12 is a diagram illustrating an example of a translated description of “Machines”.

FIG. 13 is a diagram illustrating an example of an axiom description generated at step S205.

FIG. 14 is a diagram illustrating an example of a description of “Events” before translation.

FIG. 15 is a diagram illustrating an example of a translated description of “Events”.

FIG. 16 is a diagram illustrating an example of a translated definition of “byte”.

FIG. 17 is a diagram illustrating examples of definitions of an enumerated type and an array type before translation.

FIG. 18 is a diagram illustrating examples of translated definitions of the enumerated type and array type.

FIG. 19 is a diagram illustrating an example of a definition of a communication channel before translation.

FIG. 20 is a diagram illustrating an example of a translated definition of communication channel.

FIG. 21 is a diagram illustrating an example of a definition of state transition before translation.

FIG. 22 is a diagram illustrating an example of a definition of LTL formula before translation.

FIG. 23 is a diagram illustrating an example of a translated definition of LTL formula.

FIG. 24 is a block diagram illustrating a minimum configuration of a verification property integration apparatus according to the present invention.

### DESCRIPTION OF EMBODIMENTS

### First Exemplary Embodiment

A first exemplary embodiment of the present invention will be described below with reference to drawings.

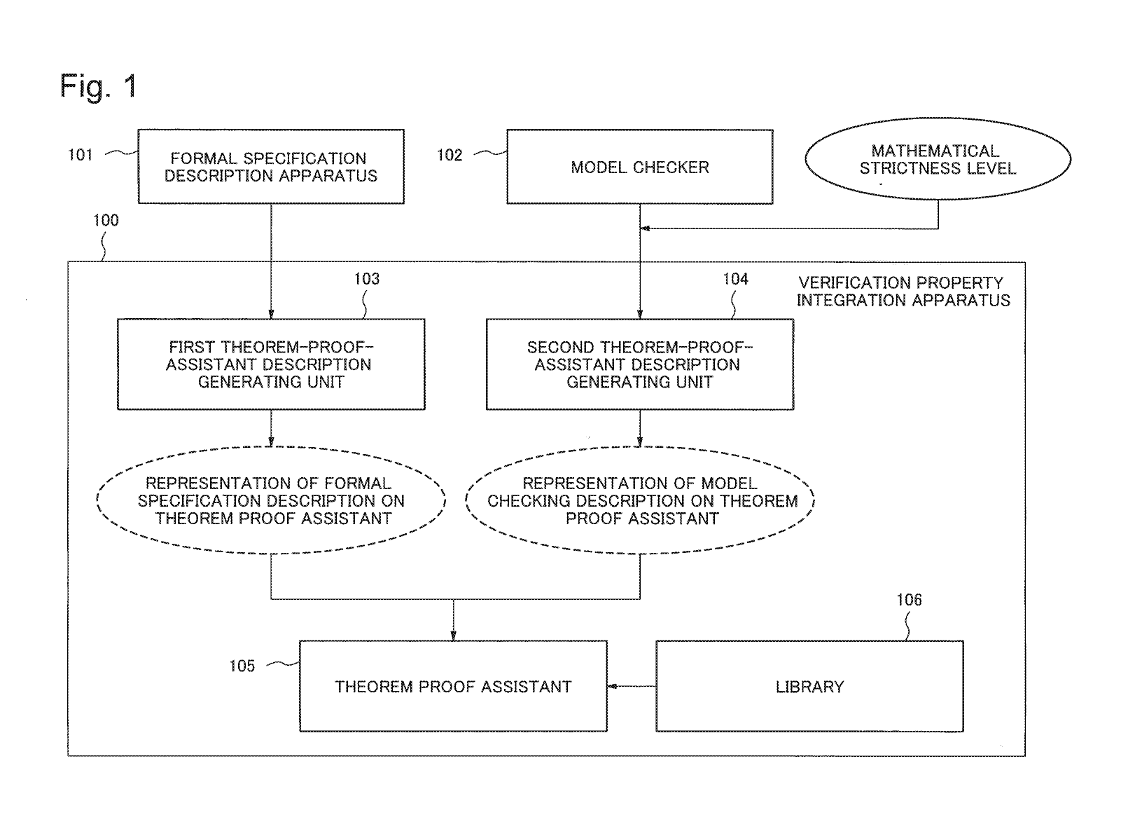

FIG. 1 is a block diagram illustrating a configuration of a first exemplary embodiment of a verification property integration system according to the present invention.

The verification property integration system includes a verification property integration apparatus 100, a formal specification description apparatus 101, and a model checker 102.

The verification property integration apparatus 100 is supplied with an input of a formal specification description (specifically, information including a specification described in formal specification description) from the formal specification description apparatus 101.

The formal specification description includes an environment definition and a system definition. The environment definition includes a type definition, a constant definition, an axiom and a module dependency. The system definition includes a refinement relation, a reference, a variable, an invariant, and an operation (event).

The verification property integration apparatus 100 is supplied with an input of a model checking description (specifically, information including a model described in model checking) from the model checker 102.

The model checking description includes a data type declaration, a communication channel, a state transition, and a checking formula.

As illustrated in FIG. 1, the verification property integration apparatus 100 includes a first theorem-proof-assistant description generating unit 103, a second theorem-proof-assistant description generating unit 104, a theorem proof assistant 105, and a library 106.

The first theorem-proof-assistant description generating unit 103 translates a formal specification description supplied from the formal specification description apparatus 101 into a representation on the theorem proof assistant. In other words, the first theorem-proof-assistant description generating unit 103 translates a formal specification description into a theorem-proof-assistant description. In the present exemplary embodiment, the first theorem-proof-assistant description generating unit 103 solves the first technical problem described above.

The second theorem-proof-assistant description generating unit 104 translates a model and a temporal logic formula in a model checking description input from the model checker 102 into representations on the theorem proof assistant. In other words, the second theorem-proof-assistant description generating unit 104 translates a model checking description into a theorem-proof-assistant description. In the present exemplary embodiment, the second theorem-proof-assistant description generating unit 104 solves the second technical problem described above.

The theorem proof assistant 105 defines a linkage between theorem-proof-assistant descriptions output from the first theorem-proof-assistant description generating unit 103 and the second theorem-proof-assistant description generating unit 104 and performs verification.

The library 106 is a library for assisting the theorem proof assistant 105 in proving. Specifically, the library 106 is a library for providing semantics of formal specification descriptions and model checking descriptions to the theorem proof assistant 105, thereby assisting checking by proof. The library 106 is stored in a storage device (not depicted) such as an optical disk device, a magnetic disk device, or a memory included in the verification property integration apparatus 100.

Note that the first theorem-proof-assistant description generating unit 103 and the second theorem-proof-assistant description generating unit 104 may be implemented by a computer that operates in accordance with a verification property integration program, for example. In this case, a central processing unit (CPU) reads the verification property integration program and operates as the first theorem-proof-assistant description generating unit 103 and the second theorem-proof-assistant description generating unit 104 in accordance with the program. The verification property integration program may be stored on any storage medium (for example, an optical disc, a semiconductor storage device, a magnetic disk or the like). The CPU may read the program stored in the storage medium through a storage medium reader or the like. The first theorem-proof-assistant description generating unit 103 and the second theorem-proof-assistant description generating unit 104 may be implemented by separate hardware components (for example, computer devices or logic circuits).

Operations of the present exemplary embodiment will be described next.

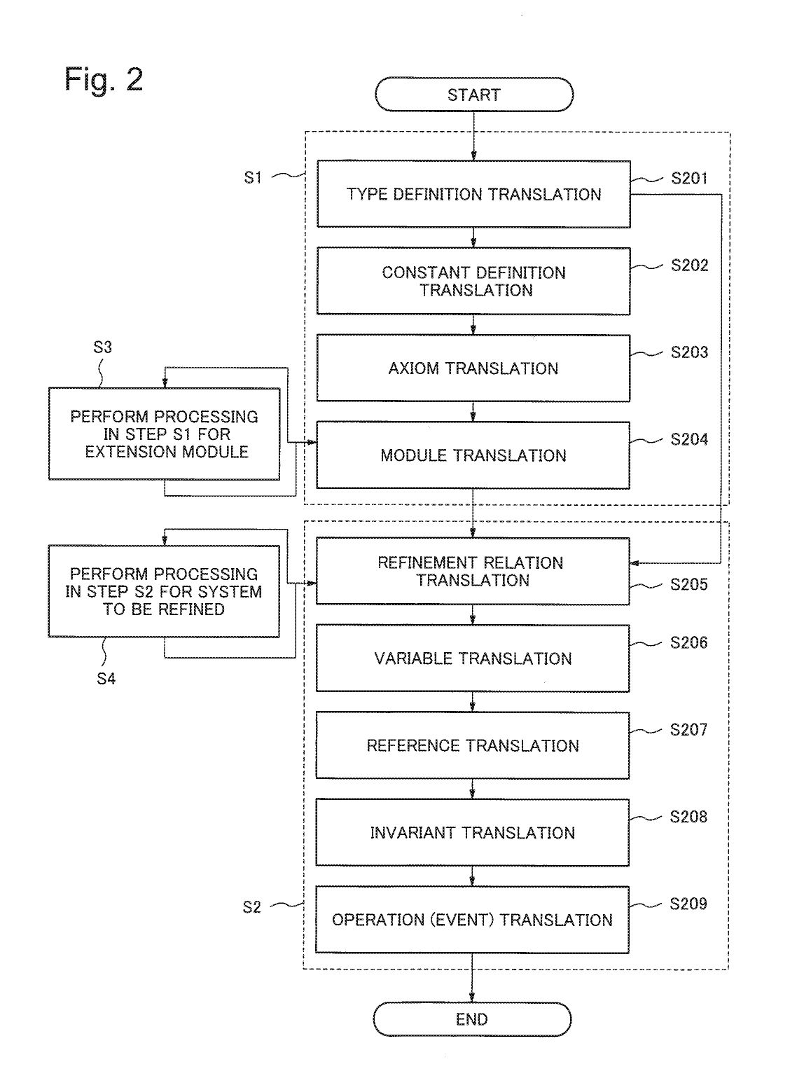

FIG. 2 is a flowchart illustrating an operation of the first theorem-proof-assistant description generating unit 103.

The first theorem-proof-assistant description generating unit 103 performs processing for translating an environmental definition in an input formal specification description into a description for the theorem proof assistant (step S1 in FIG. 2). The first theorem-proof-assistant description generating unit 103 also performs processing for translating a system definition in the input formal specification description into a description for the theorem proof assistant (step S2 in FIG. 2).

In translation of the environment definition in the formal specification description (step S1), the first theorem-proof-assistant description generating unit 103 performs translation illustrated at steps S201 through S204 as described below.

First, the first theorem-proof-assistant description generating unit 103 performs type definition translation (step S201). The result of the translation is a single module structure on the theorem proof assistant and a project (file) name of the original formal specification description is used to name the module. Because most of formal specification descriptions do not have types such as in general programing languages, and theorem proofs, an inclusion relation a set, for example, is often used to represent a variable or a reference. On the other hand, because most theory proofs have strong static type restrictions, generation of type definitions is important. In the present exemplary embodiment, the first theorem-proof-assistant description generating unit 103 generates a graph from the inclusion relation the set and generates type definitions for the theorem proof assistant in such a way that the structure of the generated graph is maintained.

In constant definition translation (step S202), literal translation based on syntax can be performed. In axiom translation (step S203), it is possible to eliminate syntactic differences by complementing type information on the basis of the type definitions generated at step S201, thereby literal translation can be performed. Module translation (step S204) is a mechanism for resolving module dependencies, and the first theorem-proof-assistant description generating unit 103 translates a module definition included in the environment definition in the formal specification description into a module read statement on the theorem proof assistant.

The first theorem-proof-assistant description generating unit 103 performs processing in step S1 (processing from step S201 through step S204) for an extension module, then proceeds to step S205 (step S3).

In the translation of the system definition in the formal specification description (step S2), the first theorem-proof-assistant description generating unit 103 performs translation from step S205 through step S209 as described below.

In refinement relation translation (step S205), the first theorem-proof-assistant description generating unit 103 translates refinement relations included in the system definition in the formal specification description into coercion descriptions that are representation for the theorem proof assistant. The refinement relations are descriptions classified as the system definition in the formal specification definition. The refinement relation represents addition of variables, references, invariants and operations (events) to an existing system. In other words, if variables, references, invariants and operations exist in the system to be refined and not all of them are defined in a refined system, the refinement is invalid and is handled as a verification failure. Accordingly, in the theorem proof assistant, it is required to represent explicitly that such incorrect refinement has not occurred and to prevent omission. Therefore, it is appropriate to use the notion of coercion.

The first theorem-proof-assistant description generating unit 103 performs processing in step S2 (processing from step S205 through step S209) for the system to be refined, then proceeds to step S206 (step S4).

In the formal specification description, a reference classified as a system definition means reading an existing variable and using its value in an operation (event). In the theorem proof assistant, on the other hand, no corresponding mechanism exists and therefore a reference is translated into an argument of an operation (event). Variables and references in formal specification descriptions do not have types, and they are defined as elements of a set. Variables and arguments in the theorem proof assistant, on the other hand, strictly need to have types. Accordingly, in variable translation (step S206) and reference translation (step S207), the first theorem-proof-assistant description generating unit 103 performs computation for determining the type of a variable or an argument from an inclusion relation of a set.

In the formal specification description, an invariant classified as a system definition is a restriction that needs to be satisfied at any given time when an operation (event) that has occurred is processed. In invariant translation (step S208), the first theorem-proof-assistant description generating unit 103 translates an invariant, which is included in the system definition in the formal specification description, into an axiom on the theorem proof assistant. The translation is processing for avoiding obligation to verify, on the theorem proof assistant, properties that have already been verified on the formal specification description after the translation.

In the formal specification definition, an operation (event) classified as a system definition defines a change (operation) to be provided to the system when a condition (a pre-condition) is satisfied. In operation (event) translation (step S209), the first theorem-proof-assistant description generating unit 103 generates that definition as follows. In general, the meaning of an operation (event) is defined by operational semantics. In the present exemplary embodiment, an operation (event) is defined as an inductive set on the theorem proof assistant and an inductive predicate logic for the set. The predicate logic defines an operational semantics of the operation (event). The predicate logic represents a restriction that needs to be satisfied for a state X to transition to Z as a result of occurrence of operation Y in the state X. The restriction is a predicate logic generated by translating only the syntax of a pre-condition and an operation. How to create the translation is obvious but a certain idea is required in order to determine to define an operational semantics as an inductive predicate logic. Such an idea enables generation of a semantic representation on the theorem proof assistant that corresponds to a given any operation (event) definition.

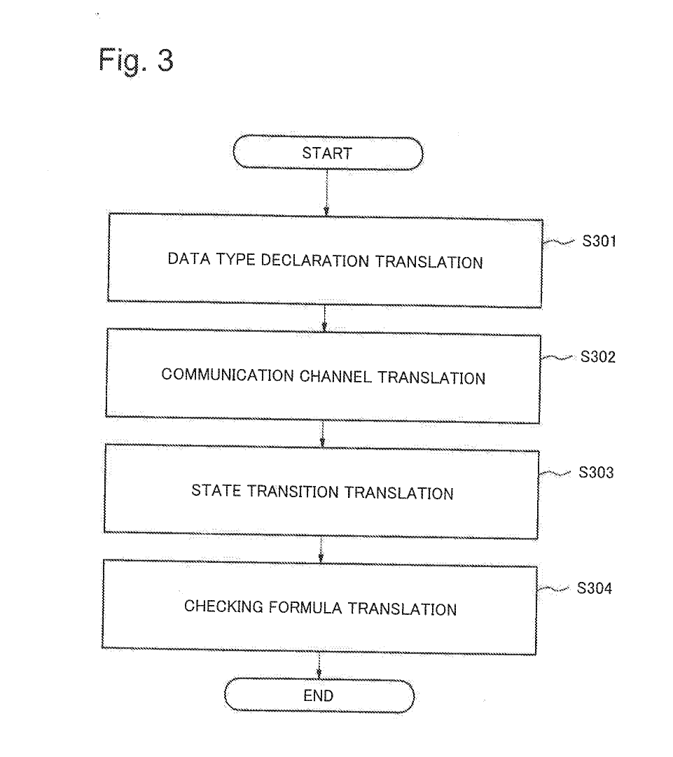

FIG. 3 is a flowchart illustrating an operation of the second theorem-proof-assistant description generating unit 104. The second theorem-proof-assistant description generating unit 104 performs the process illustrated in FIG. 3 for an input model checking description as follows. The second theorem-proof-assistant description generating unit 104 performs data type declaration translation (step S301), communication channel translation (step S302), state transition translation (step S303), and checking formula translation (step S304). In this way, the second theorem-proof-assistant description generating unit 104 translates the descriptions in the model checking description into their corresponding descriptions on the theorem proof assistant.

The purpose of the data type declaration in the model checking description is to construct a complex data type by combining primitive types. The constructed complex data type is used for defining a state transition and a communication channel. For the data type declaration translation (step S301), it is required that firstly the primitive types can be translated and secondly the complex data type constructed from a given complex data type can be translated.

Translation of primitive types needs some devising. In general, types handled in theorem proof assistants are types that have been inductively constructed and have infinite size. Specifically, examples of such types include natural numbers and rational numbers. In the model checking description, on the other hand, only finite-size types can be used. Examples of such types include 32-bit integers, characters and arrays of integers and characters. In translation of primitive types, this difference needs to be taken into consideration. This is because properties that hold in a model that permits only finite-size types may not hold in a model that permits infinite-size types and vice versa. For example, if a property assuming an operation performed when an overflow of a variable has occurred is applied to a model in which no overflow occurs, the property may not hold. An example of the opposite may be a comparison of numerical values that cannot be represented by a finite-size type.

For the reasons described above, in order to perform strict verification, finite-size types need to be constructed on the theorem proof assistant. For that purpose, firstly a library in which theorems concerning primitive finite types, arithmetic operations and their properties are defined is required. Secondly, correspondence rules for translation are required. In the theorem proof assistant, a definition of a type that needs to have a finite size is implemented by explicitly indicating the number of digits of the type. Arithmetic operations for the types are provided as definitions, and proofs are provided for theorems concerning the definitions of the arithmetic operations to implement finite-size types in the theorem proof assistant.

However, the use of finite-size types and their arithmetic operations can significantly increase the number of steps of proofs on the theorem proof assistant. Therefore, in order to facilitate checking by theorem proofs at the sacrifice of strictness of checking, the second theorem-proof-assistant description generating unit 104 in the present exemplary embodiment is allowed to use inductive types having infinite sizes as well. Specifically, in the data type declaration translation (step S301), the second theorem-proof-assistant description generating unit 104 can select a type of a variable on the theorem proof assistant, according to a user's convenience.

For any complex data type in the model checking description, the base primitive data types that make up the complex data type are translated as described above. The complex structure is translated into an inductive data structure.

In model checking description, a communication channel is used for representing event communication. The communication channel has a buffer. When a process performs transmission to the target communication channel, a message is added to the buffer. When the process receives a message from the target communication channel, the message at the head of the buffer is removed. In order to represent this on the theorem proof assistant, the second theorem-proof-assistant description generating unit 104 translates communication channel declarations into independent queue structures in the communication channel translation (step S302).

In model checking, the system includes a plurality of processes and cooperative operations that use a communication channel are checked. Each of the processes is defined using a sequence of operations. The syntax can be represented using Backus Naur Form (BNF) and can be translated into a representation in the theorem proof assistant by defining translation for each of the elements in BNF. In the state transition translation (step S303), the second theorem-proof-assistant description generating unit 104 performs translation based on the definitions of the translation.

At step S303, the second theorem-proof-assistant description generating unit 104 first extracts process names and constructs a set of the process names. The second theorem-proof-assistant description generating unit 104 then constructs a type of a state from a defined variable and information about a communication channel and its type. The second theorem-proof-assistant description generating unit 104 then translates operations, which are a process defined as a sequence, as functions on the state type. Lastly, the second theorem-proof-assistant description generating unit 104 translates a restriction on state transitions to an inductive predicate logic formula.

In order to check a property of the model checking description, a temporal logic formula (a mathematical formula based on a temporal logic), called a checking formula is used. In order to use the checked property in the theorem proof assistant, the formula needs to be translated. A call to a special library (for example, the library 106 in FIG. 1) is used for representing the translation of the formula. Because the checking formula is described by a combination of operators representing the reachability in a state space, the library is constructed for defining the meaning and assisting the proof. The library holds definitions of meanings of the operators and theorems for translating the operators. Using the library, literal translation can be performed. In the checking formula translation (step S304), the second theorem-proof-assistant description generating unit 104 uses the library to translate the checking formula into a theorem-proof-assistant description.

The library 106 is a mechanism for assisting in proving. Specifically, the library 106 stores theorems and the proofs of the theorems with regard to properties that frequently appear in formal specification descriptions and model checking descriptions, by taking into consideration the convenience in proving of those properties. Examples of such theorems include a theorem that determines the relationship between operators in a temporal logic in model checking, such as a theorem for removing double negations used in general logic. The library 106 defines semantics by unique representations, on the theorem proof assistant, used by the verification property integration apparatus 100, on the basis of known theorems.

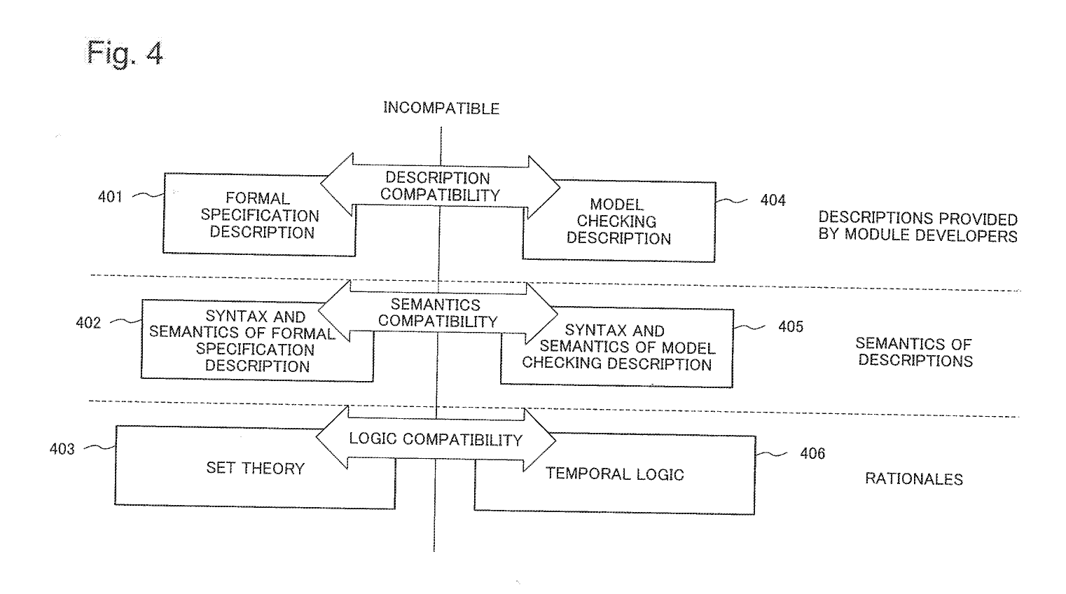

FIG. 4 is a diagram schematically illustrating an interrelationship between a formal specification description 401 and a model checking description 404 before the present invention is carried out. As illustrated in FIG. 4, the formal specification description 401 is described based on its own syntax and semantics (syntax and semantics of formal specification description 402) and its mathematical basis is set theory 403. On the other hand, the model checking description 404 is described based on its own syntax and semantics (syntax and semantics of model checking description 405) and its mathematical basis is temporal logic 406. Because the formal specification description 401 and the model checking description 404 are based on different bases, there is no common logic for integrating the descriptions. Therefore, when a product verified using the formal specification description 401 and a product verified using the model checking description 404 are to be integrated, their properties needed to be integrated into one of the descriptions or into another description means.

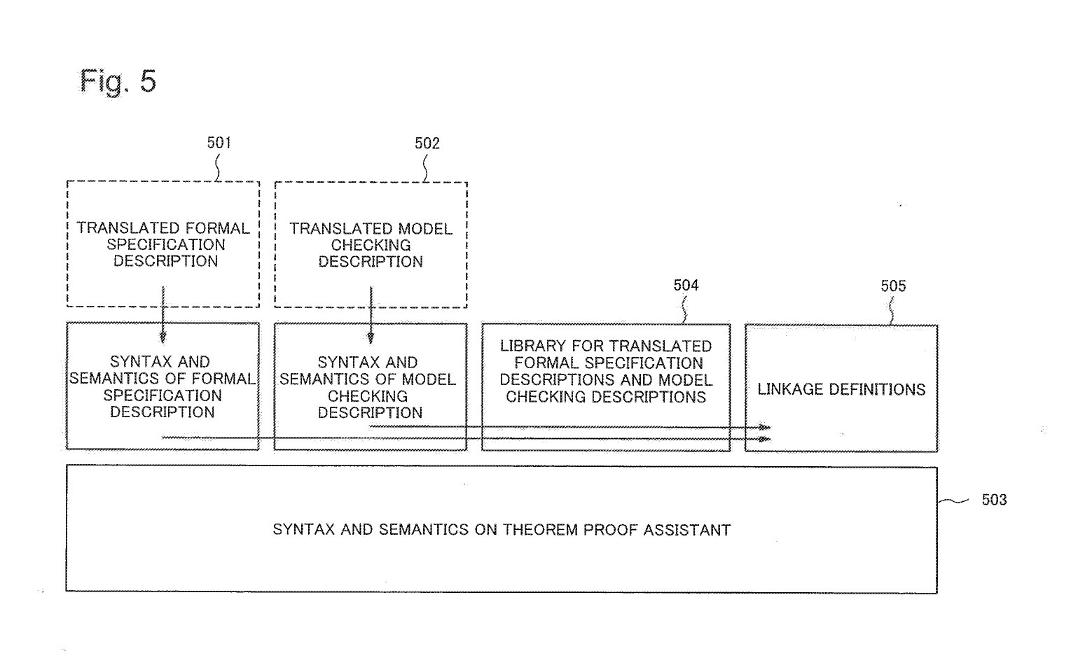

The present invention enables a formal specification description and a model checking description to be translated into descriptions on a theorem proof assistant. FIG. 5 is a diagram schematically illustrating an interrelationship between a translated formal specification description 501 (hereinafter simply referred to as the formal specification description 501) and a translated model checking description 502 (hereinafter simply referred to as the model checking description 502) and linkage definitions 505 after the present invention is carried out. The formal specification description 501 is a description on the theorem proof assistant translated from the input formal specification description 401. The model checking description 502 is a description on the theorem proof assistant translated from the input model checking description 404. For each of the formal specification description 501 and the model checking description 502, semantics (syntax and semantics on theorem proof assistant 503) has been constructed on the theorem proof assistant. Furthermore, the formal specification description 501 and the model checking description 502 are dependent on definitions in a library in which theorems used in checking their properties by using proofs are contained (library for translated formal specification descriptions and model checking descriptions 504). A first advantageous effect of the present invention therefore is that a linkage between a translated formal specification description and a translated model checking description can be defined on a theorem proof assistant, and the linkage can be checked.

A second advantageous effect is that existing products can be more easily combined and can be safely integrated into one. This is because there is no need for checking products that have been already checked by using an existing formal specification description and model checking description again, on the basis of another formal method.

Some international standards for specifying safety evaluate whether formal methods have been used, and extent to which formal methods have been applied. A third advantageous effect of the present invention is that a specified safety standard can be easily satisfied and evaluation for whether the safety standard is satisfied can be easily made. This is because safety and reliability can be easily ensured and the extent of the properties can be easily traced, comparing to a case in which only existing products used as components are checked and properties of a product or system into which the existing products are integrated are not checked.

As stated above, the present invention can be used for purposes of checking properties when software programs, systems or apparatuses that have been verified using existing formal specification descriptions, model checking or theorem proving are integrated or combined together and used.

Specific examples to which the present invention is applicable will be described below.

### EXAMPLE 1

In the present specific example, a description(s) in Event-B which is formal specification description with regard to one or more systems, and a description(s) (written in Promela) in SPIN which is a model checker with regard to one or more systems, are supplied as input. Each of the inputs is translated into descriptions on a Coq (written in Gallina) which is a theorem proof assistant.

In the present specific example, as illustrated in FIG. 1, a formal specification description apparatus 101 outputs one or more descriptions in Event-B, each of which is translated into a theorem-proof-assistant description by a first theorem-proof-assistant description generating unit 103.

Each of the descriptions in Event-B includes “Contexts” and “Machines” descriptions. In the Contexts, definitions of “Sets”, “Constants”, “Axioms”, “Theorems” and “Extends” are described. In the “Machines”, definitions of “Refines”, “Sees”, “Variables”, “Invariants” and “Events” are described.

An operation of the present specific example will be described next.

“Contexts” (context description block) describes definitions concerning an environment. One or more context descriptions (“Contexts”) are contained in the “Contexts”. The “Contexts” are translated by steps S201 through S204 included in the translation of environment definitions in the formal specification description (step S1) into a single Class declaration and Instance definition. Strings obtained by appending character string “ContextsType” and “Contexts” to a project name are used as a Class name and an Instance name, respectively. If “Contexts” is not included in the input, the first theorem-proof-assistant description generating unit 103 skips the translation at step S1 and starts translation at step S205.

“Sets” is a description block that defines sets. The first theorem-proof-assistant description generating unit 103 translates a definition of a set written in the “Sets” into a type definition on Coq in the type definition translation (step S201). For example, if definition “A” is contained in the “Sets” and a restriction, “A=Z”, is contained in the “Axioms”, the description is translated into “Definition A:=Z.” on Coq. Specifically, the first theorem-proof-assistant description generating unit 103 translates the description “Set A exists and set A is a set of integers” into the description “Type A is an integer type”.

“Constants” is a description block for declaring constants. The first theorem-proof-assistant description generating unit 103 translates a constant in the “Constants” into a constant on Coq in the constant definition translation (step S202). For example, if a constant, “Bob”, is defined and a restriction, “Bob E Person”, is contained in “Axioms”, then the description is translated into the description “Variable Bob: Person”.

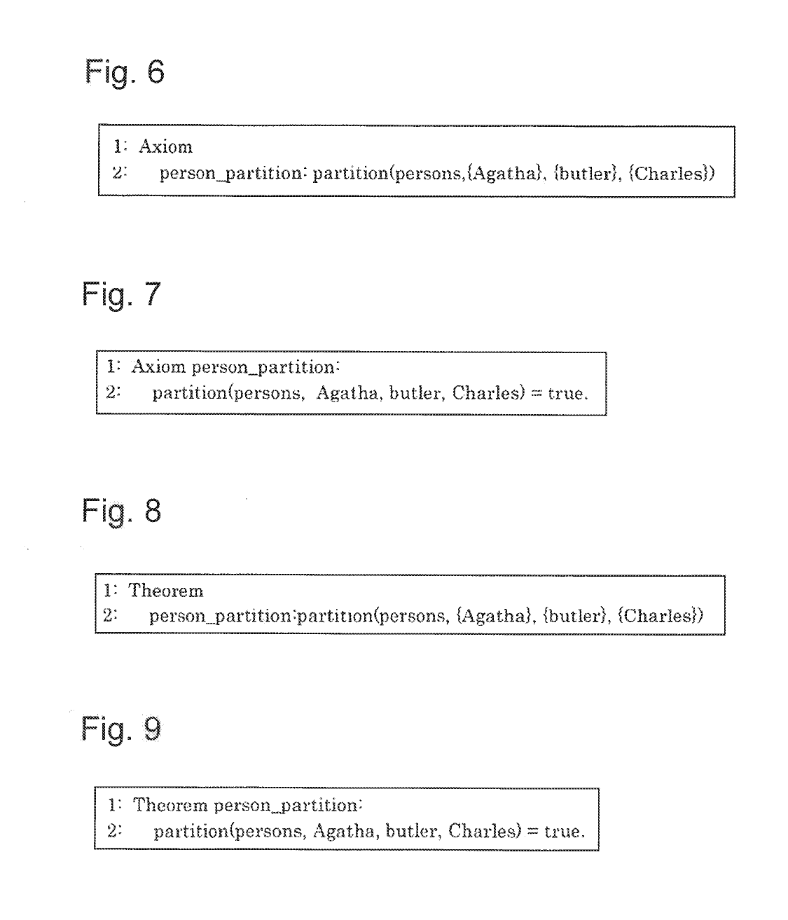

“Axioms” and “Theorems” are description blocks for declaring axioms and theorems, respectively. In the description block, a restriction of a set and a constant is described. The first theorem-proof-assistant description generating unit 103 translates the axioms and theorems into descriptions on the theorem proof assistant in the axiom translation (step S203). For example, if a description of an “Axioms” illustrated in FIG. 6 is given, the first theorem-proof-assistant description generating unit 103 translates the description into a description illustrated in FIG. 7.

“Theorems” is a description block for declaring theorems. As in the “Axioms”, properties that need to hold are described in the “Theorems”. The “Theorems” differs from the “Axioms” in that proof obligations are generated at the same time. Accordingly, the description of “Theorem” can be translated in the same way as the description of “Axioms”. For example, when a description illustrated in FIG. 8 is given, the first theorem-proof-assistant description generating unit 103 translates the description into a description illustrated in FIG. 9.

“Extends” is a description block for declaring an extension(s) of one or more existing “Contexts”. For this description block, the first theorem-proof-assistant description generating unit 103 first performs the translation (step S1) of a “Context” for which “Extends” is to be declared in the module translation (step S204).

The translated “Context” is a “Class”. The first theorem-proof-assistant description generating unit 103 then copies the content of the “Class” into a “Class” definition in the current “Context” to be translated. The first theorem-proof-assistant description generating unit 103 then copies a definition from the “Instance” for which “Extends” is to be declared to the “Instance” in the “Contexts” (the translated “Contexts” on Coq). Lastly, the first theorem-proof-assistant description generating unit 103 generates coercion for a “Class” of an existing “Context” from the “Context” to be translated. If the input is a valid Event-B description, the above-described coercion is a pure extension (all of the elements of the existing “Contexts” are new “Contexts”) for “Contexts” described in the “Extends” block. In this way, “Contexts” in Coq can be always automatically generated using coercion for “Contexts” contained in an input (an Event-B description).

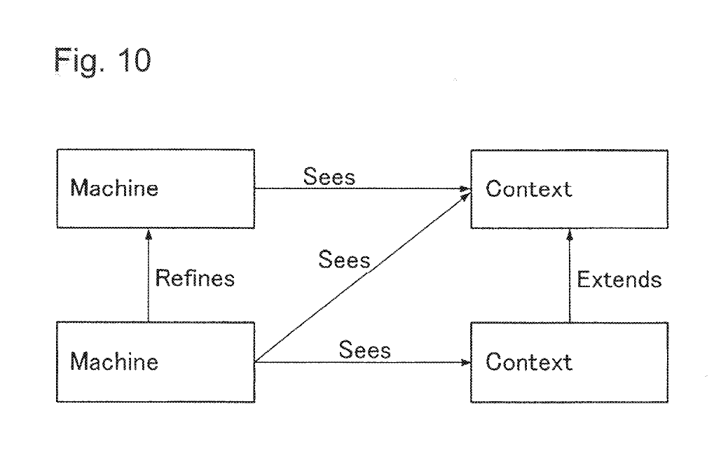

FIG. 10 is a diagram illustrating the relationship between extension and refinement of a model in Event-B. “Context” in the lower part of FIG. 10 represents an extension of the “Context” in the upper part of FIG. 10. The module translation (step S204), the constant definition translation (step S202) and the axiom translation (step S203) may be performed in a different order.

“Machines” is a description block for defining the behavior of a system of interest. One or more machine descriptions (“Machine”) are contained in the “Machines”. A “Machine” is translated into a “Class” and an “Instance” by steps S205 through S209 included in the translation (step S2) of a system definition in a formal specification description. A notation (such as a character string) representing that “MachinesType” or “Machines” are appended to a name given to the “Machine” is used as the name of each of the “Class” and “Instance”.

“Refines” is refinement of an existing “Machine”. Refinement is a description of an existing “Machine” to which a restriction is added or a description of an existing “Machine” of which restriction is strengthened. Furthermore, a linkage invariant (called a “gluing invariant”) that determines the relationship between a new variable introduced during the refinement and an existing variable needs to be satisfied. If an object to be translated is “Refines” (refinement of an existing Machine), the second theorem-proof-assistant description generating unit 104 cannot start the processing at step S205 and therefore aborts the processing at step S205 and jumps to the processing at step S201. Then the second theorem-proof-assistant description generating unit 104 performs steps S201 through S209 for a depending object to be refined and then resumes the aborted processing at step S205. In the resumed processing at step S205, the second theorem-proof-assistant description generating unit 104 translates the “Refines” into an “Axiom” on Coq in order to represent formally the properties of the refinement in an appropriate manner, in addition to representing the fact that the “Refines” is refinement of the existing “Machine”. In other words, the “Axiom” represents the axiom that when a pre-condition of the result of the refinement is satisfied for each event, a pre-condition of the event to be refined is satisfied.

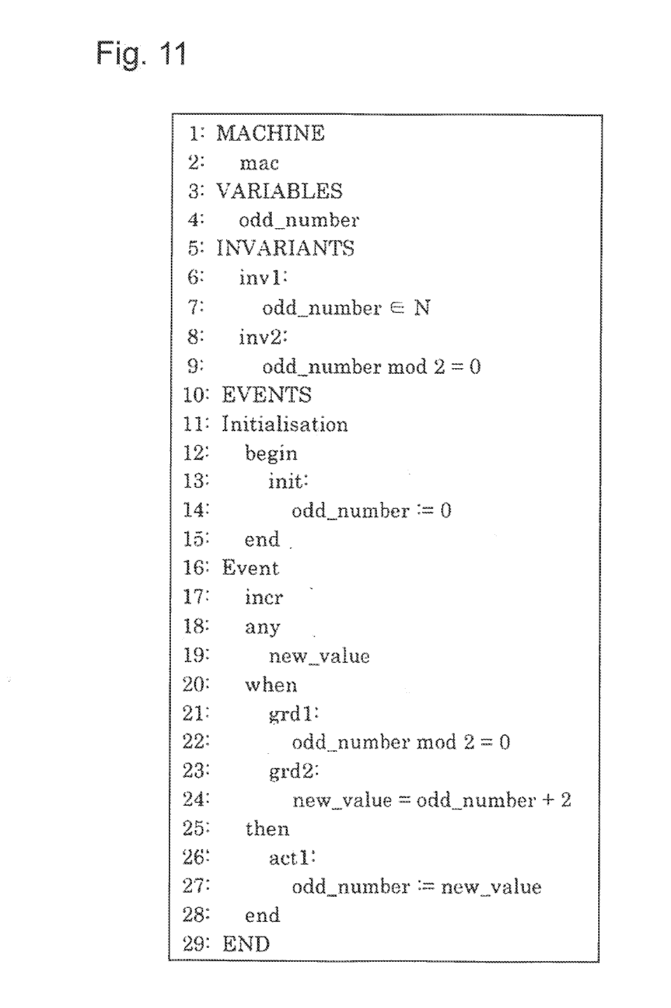

For example, assume that there is an existing “Machine” illustrated in FIG. 11.

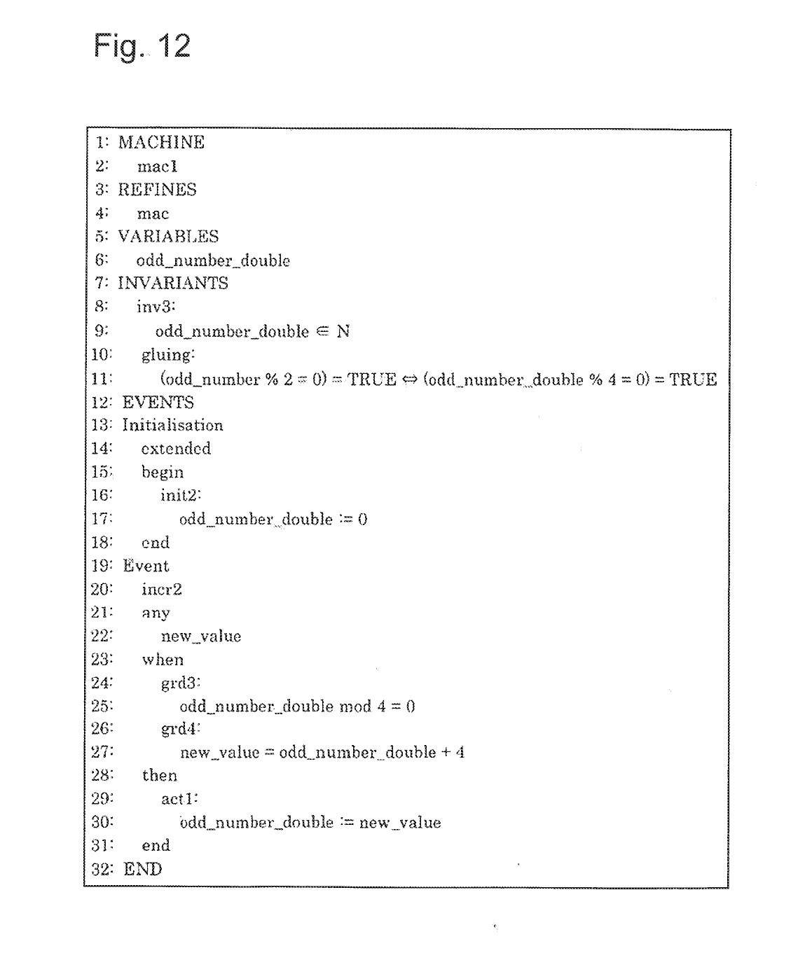

In addition, assume that there is refinement illustrated in FIG. 12 for the “Machine” illustrated in FIG. 11.

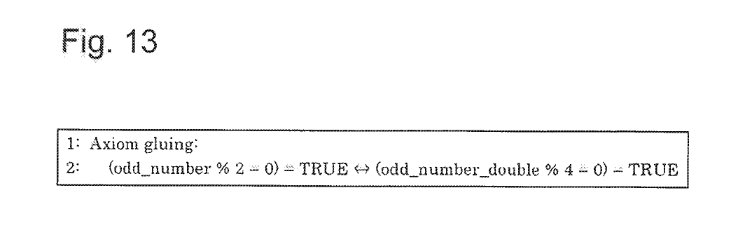

The “gluing invariant” in this case is a description on lines 10-11 in FIG. 12 and an axiom illustrated in FIG. 13 is generated from the “gluing invariant”.

On the other hand, there is no refinement for an existing event, no axiom is generated for the strength of the pre-condition.

“Variables” is a description block for defining variables that the “Machine” needs to have. Translation of the “Variables” is performed by the variable translation (step S206), but this translation is technically similar to the translation of the constant definitions included in the “Context” (step S202). The order of the translation and the refinement relation translation (step S205) may be altered.

“Sees” is a description block indicating that reference is made to an existing “Context” (the right-pointing arrow in FIG. 10). In translation of references of “Sees” (step S207), the second theorem-proof-assistant description generating unit 104 places the “Class” and “Instance” descriptions generated at step Si for the “Context” of interest, respectively in the “Class” and “Instance” descriptions of the “Machine” to be generated. This enables the “Machine” of interest to refer to the descriptions in the specified “Context”.

“Invariants” is a description block for declaring properties to be prevented from being destroyed by execution of an event, which will be described later. “Invariants” are translated into “Axioms” in the invariant translation (step S208). The translation is technically the same as the axiom translation (step S203), and different “Class” is defined (“Invariants” are placed in the “Class” for the “Machine”).

“Events” is a description block for defining operations to be executed for the “Machine”. “Events” are translated by the operation (event) translation (step S209) into an event set and semantics given to the elements of the event set on Coq. The event set includes event names included in the “Events” and the semantics is translated into inductive predicates from the definitions of the events.

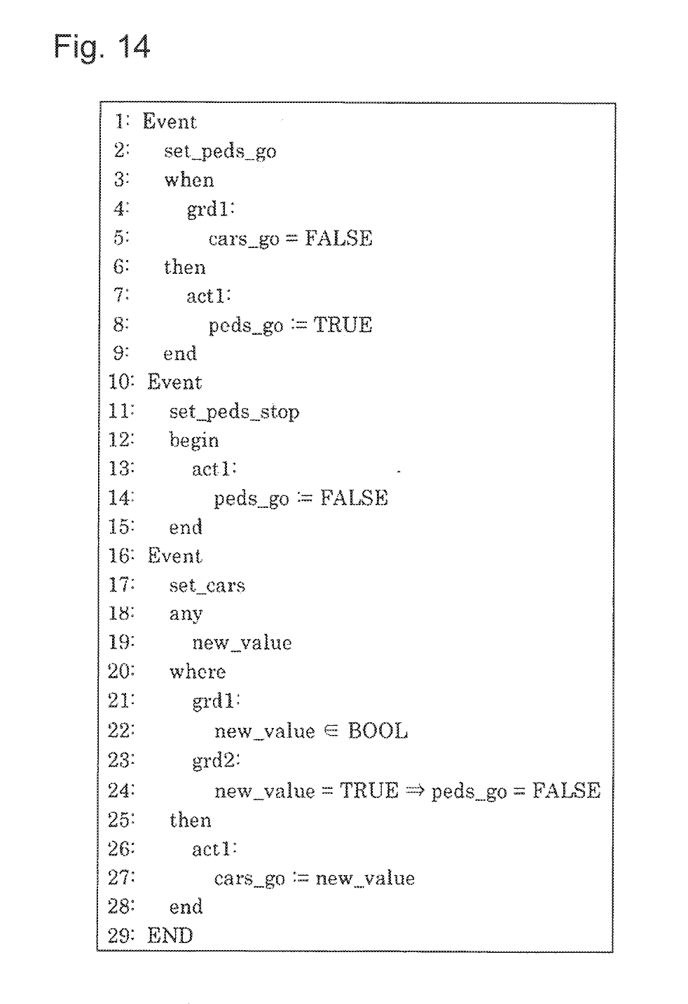

For example, assume that a definition illustrated in FIG. 14 is given.

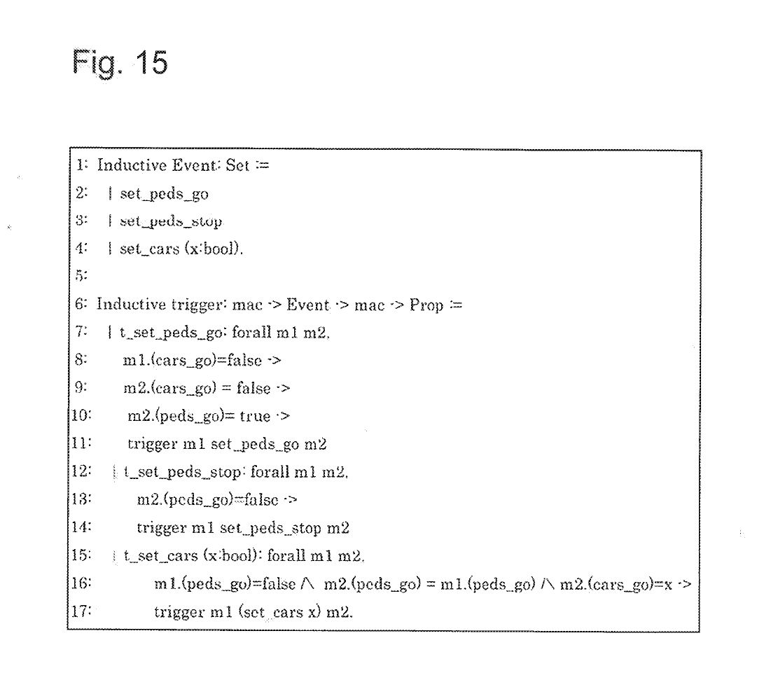

Three events, “set_peds_go”, “set_peds_stop”, and “set_cars”, are used in the definition. Accordingly, the second theorem-proof-assistant description generating unit 104 generates a set of these three events and predicates indicating their semantics as illustrated in FIG. 15.

The model checker 102 in FIG. 1 outputs one or more descriptions in SPIN (Promela), and the second theorem-proof-assistant description generating unit 104 translates each of such descriptions into a theorem-proof-assistant description.

A system in SPIN is made up of four sections. In addition to a type definition, a communication channel definition, and a process definition, a linear temporal logic (LTL) checking formula for checking the properties of the system is translated. Translation of each of the components will be described with reference to FIG. 3.

A type definition in SPIN is translated into a type definition on Coq in the data type declaration translation (step S301). Base types that can be used in SPIN include “bit” and “bool” types which hold true and false values, a “byte” type which indicates a positive 8-bit integer, a “short” type which indicates a signed 8-bit integer, and an “int” type which indicates a signed 16-bit integer. These data types represent values that have fixed data sizes. When the level of mathematical strictness, which is given as an input in FIG. 1, is specified as “mathematically strict”, the second theorem-proof-assistant description generating unit 104 uses data types in Coq that correspond to the data types. On the other hand, when the level of mathematical strictness is specified as “mathematically non-strict”, the second theorem-proof-assistant description generating unit 104 uses an infinite integer type (“Z”), which allows easier checking by proof.

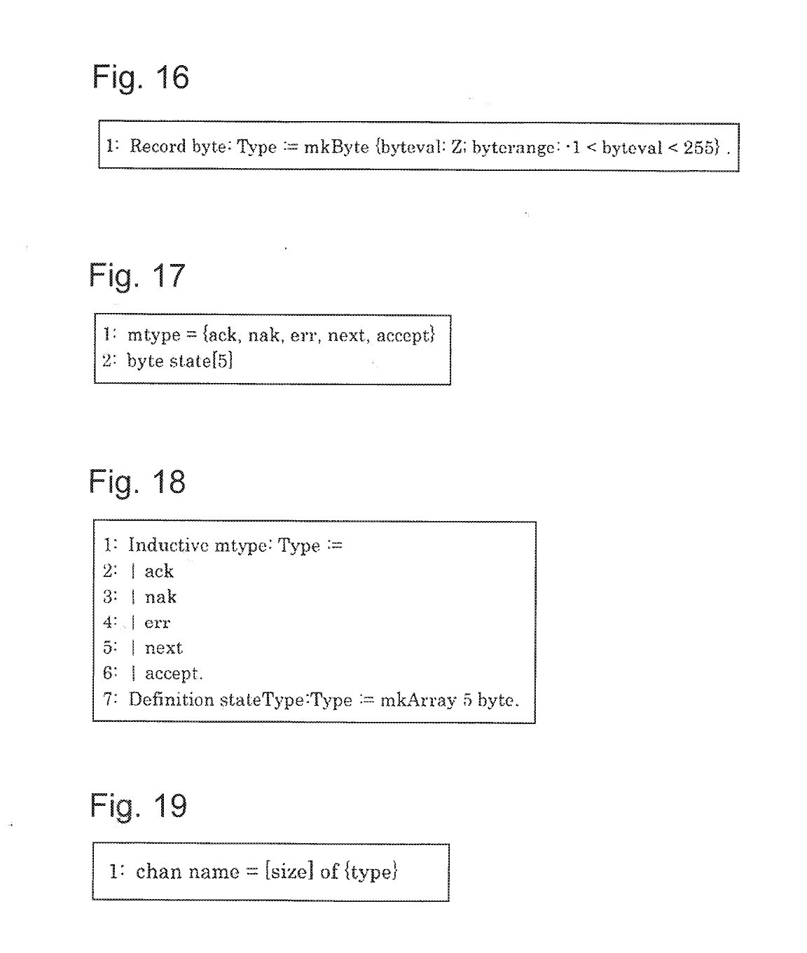

For example, when the level of mathematical strictness is specified as “mathematically strict”, a “byte” definition can be translated into a definition illustrated in FIG. 16.

In the definition illustrated in FIG. 16, data of any “short” type can be represented while at the same time a value range restriction on the any short type is required. Consequently, behavior (such as an overflow) of an arithmetic operation for the “short” type can be defined. However, in order to define behavior of an arithmetic operation for the “short” type, it is required to provide a basis representing that an overflow does not occur for each arithmetic operation, or to perform case analysis for an overflow.

An enumerated type and an array type are included as other types in SPIN. The enumerated type is translated into an inductive set. The array type is translated into a finite-length list structure for the base types mentioned above. For example, consider definitions of the enumerated type and the array type illustrated in FIG. 17.

The descriptions illustrated in FIG. 17 are translated into descriptions illustrated in FIG. 18.

Any communication channel in SPIN is defined by a syntax illustrated in FIG. 19.

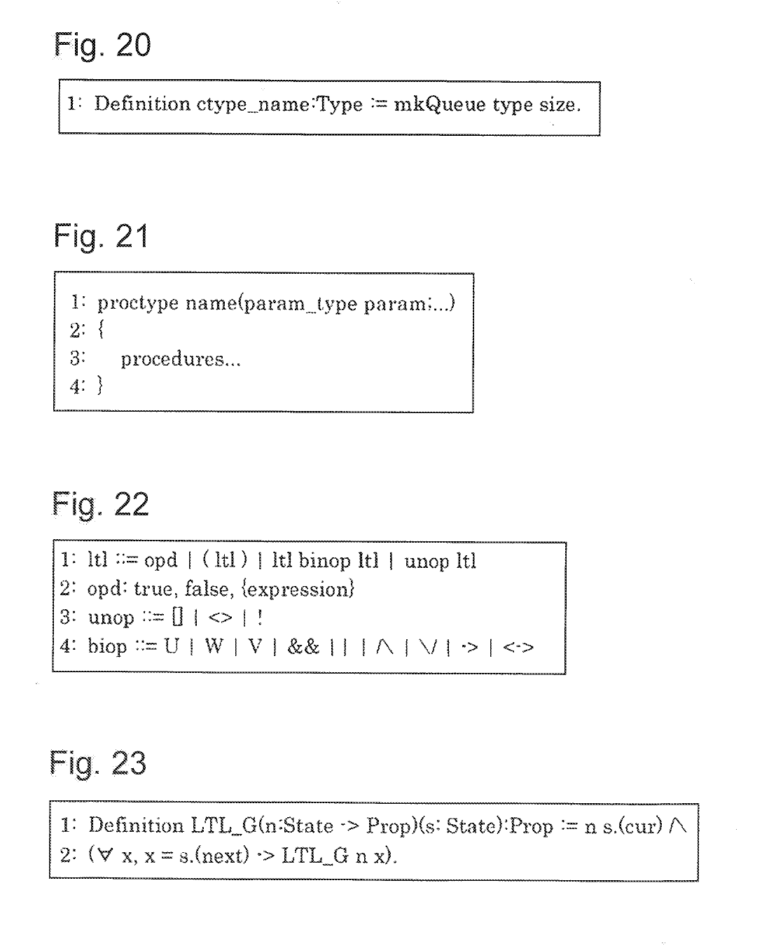

The syntax illustrated in FIG. 19 represents that a communication channel named “name” is used for passing elements of a “type” data type and its buffer size is “size”. The declaration of the communication channel is translated into a representation (syntax illustrated in FIG. 20) on Coq in the communication channel translation (step S302).

A definition of a state transition by SPIN is described by one or more processes and initialization. The definition of a process is composed of a string of a process name, a parameter and an instruction as illustrated in FIG. 21.

In the state transition translation (step S303), the second theorem-proof-assistant description generating unit 104 first generates a directed graph indicating the positions of instructions of each process from each process definition. An instruction is described on each edge of the directed graph. The second theorem-proof-assistant description generating unit 104 then extracts parameters and local variables and defines a record type made up of the extracted parameters and local variables. A pair of an instance of the record type and an instruction position of the process on the directed graph indicates a state of the process.

Each instruction is composed of substitution (regardless of whether an arithmetic operation is present or not), selection, iteration, unconditional jump, and message transmission and reception. The selection, iteration, unconditional jump and message reception among these elements are extracted as a structure of the directed graph of a process. Therefore, the second theorem-proof-assistant description generating unit 104 needs to define only the semantics of the substitution and message transmission. The substitution for a local variable means, as a change of the state of the process, that a value on the record is rewritten and the instruction position is incremented. The substitution for a global variable and message transmission change the state of the entire system as described below.

The state of the entire system is made up of a state of each process and sets of a value of a global variable and a state of a channel. Substitution for the global variable and message transmission mean that the global variable and the state of the channel are rewritten and the instruction position in the process is incremented.

In SPIN, LTL checking formulas are used for performing checking. LTL formulas used in SPIN are defined in BNF illustrated in FIG. 22.

Syntax similar to the representation illustrated in FIG. 22 can be defined on Coq, and the LTL formula is translated in the checking formula translation (step S304). The meanings of operators that appear here can be defined on a library with regard to states of the system. For example, the meaning of “└ ┘” is defined in the library as illustrated in FIG. 23. “s.(cur)” in FIG. 23 is the current state on “State” and “s.(next)” is a set of states to which transition can be non-deterministically made from “s.(cur)”.

The theorem proof assistant 105 in FIG. 1 takes, as inputs, descriptions that are translated from Event-B and SPIN descriptions by use of definitions in the library 106. When a user verifies linkages among a plurality of products, the user performs checking by proving using the theorem proof assistant (Coq in this specific example).

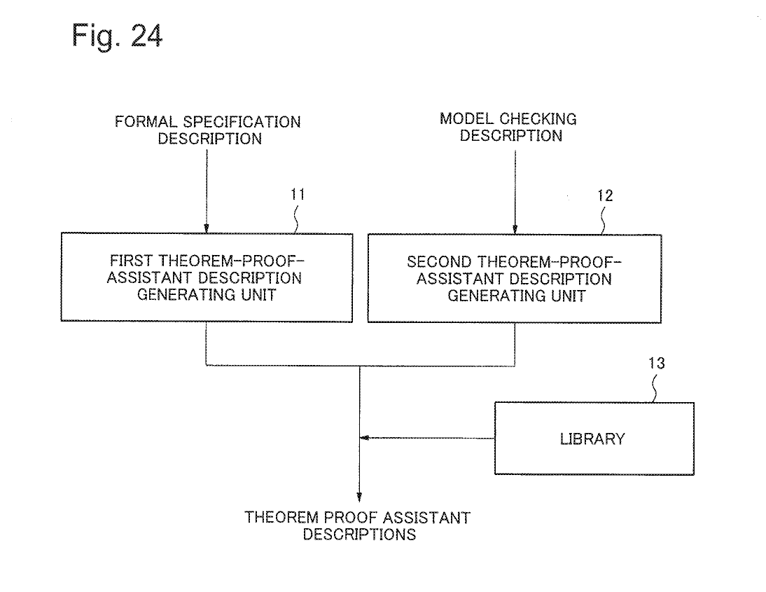

A summary of the present invention will be given next. FIG. 24 is a block diagram illustrating a minimum configuration of a verification property integration apparatus according to the present invention. The verification property integration apparatus (corresponding to the verification property integration apparatus 100 depicted in FIG. 1) according to the present invention includes a library 13 (corresponding to the library 106 in the verification property integration apparatus 100 in FIG. 1) in which semantics of a formal specification description and a model checking description to be provided to a theorem-proof-assistant description are defined. The verification property integration apparatus according to the present invention further includes a first theorem-proof-assistant description generating unit 11 (a first theorem-proof-assistant description generating means, which is corresponding to the first theorem-proof-assistant description generating unit 103 in the verification property integration apparatus 100 in FIG. 1) which translates the formal specification description into a representation on a theorem proof assistant by using the library 13. The verification property integration apparatus according to the present invention further includes a second theorem-proof-assistant description generating unit 12 (a second theorem-proof-assistant description generating means, which is corresponding to the second theorem-proof-assistant description generating unit 104 in the verification property integration apparatus 100 in FIG. 1) which translates a model and a temporal logic formula in the model checking description into representations on the theorem proof assistant by using the library 13.

The configuration described above enables to define linkages for the translated formal specification description and the model checking description on the theorem proof assistant, and to check the linkages on the theorem proof assistant. The configuration eliminates the need for checking products that have been checked using an existing formal specification description and model checking again on the basis of another formal method. The configuration enables to combine more easily existing products and to integrate safely into a product. Furthermore, safety and reliability can be easily ensured and the extent of the properties of the linkages can be easily traced, comparing to a case in which only existing products used as components are checked and the properties of the linkages are not checked. Therefore, it is possible to satisfy a specified safety standard more easily, and whether the safety standard is satisfied or not can be easily evaluated.

The first theorem-proof-assistant description generating unit 11 may use coercion for refinement relations included in a formal specification description, may generate an axiom that indicates refinement, and may handle pre-conditions, invariants or post-conditions, which are notions that do not exist in a theorem proof assistant, on semantics. Such a configuration can avoid obligation to verify properties, which have already been verified on the formal specification description, again on the theorem proof assistant after the translation.

The second theorem-proof-assistant description generating unit 12 may select a type of a variable on the theorem proof assistant in accordance with mathematical strictness or ease of proof. For example, such a configuration enables the use of an inductive type that has infinite size at the sacrifice of strictness of verification, when the use of a finite type and its arithmetic operations can significantly increase the number of steps required for proving on the theorem proof assistant. This facilitates checking by theorem proving.

The second theorem-proof-assistant description generating unit 12 may construct a state of an entire system in model checking as a state of each individual process, states of communication channels and states of variables and may define checking formulas used for model checking as predicates on the theorem proof assistant. Such a configuration enables properties that have been verified using a model checking description to be handled on the theorem proof assistant.

A description in Event-B may be supplied as input to the first theorem-proof-assistant description generating unit 11 and a description in SPIN may be supplied as input to the second theorem-proof-assistant description generating unit 12. The first theorem-proof-assistant description generating unit 11 and the second theorem-proof-assistant description generating unit 12 may translate the supplied descriptions into descriptions on a theorem proof assistant, Coq. Such a configuration enables properties that have been verified in Event-B and SPIN to be handled on Coq.

At least one of a description in Event-B and a description in VDM may be input into the first theorem-proof-assistant description generating unit 11, and at least one of a description in SPIN and a description in UPPAAL may be input into the second theorem-proof-assistant description generating unit 12. The first theorem-proof-assistant description generating unit 11 and the second theorem-proof-assistant description generating unit 12 may then translate the input descriptions into representations in any of Coq, Isabelle and PhoX, which are theorem proof assistants. Such a configuration enables properties that have been verified in Event-B, VDM, SPIN and/or UPPAAL to be handled on Coq, Isabelle or PhoX.

While the present invention has been described using the exemplary embodiments as model examples. However, the present invention is not limited to the exemplary embodiments described above. Various modes which will be apparent to those skilled in the art can be used within the scope of the present invention.

This application is based upon and claims the benefit of priority from Japanese Patent Application No. 2014-085270 filed on Apr. 17, 2014 and the entire disclosure of which is incorporated herein by reference.

### REFERENCE SIGNS LIST

11, 103 First theorem-proof-assistant description generating unit
12, 104 Second theorem-proof-assistant description generating unit
13, 106 Library
100 Verification property integration apparatus
101 Formal specification description apparatus
102 Model checker
105 Theorem proof assistant
401 Formal specification description
402 Syntax and semantics of formal specification description
403 Set theory
404 Model checking description
405 Syntax and semantics of model checking description
406 Temporal logic
501 Translated formal specification description
502 Translated model checking description
503 Syntax and semantics on theorem proof assistant
504 Library for translated formal specification descriptions and model checking descriptions
505 Linkage definitions

What is claimed is:

1. A verification property integration apparatus comprising:
a library that is configured to provide definition of semantics of a formal specification description and a model checking description which are to be provided to a theorem-proof-assistant description;
a first theorem-proof-assistant description generating unit that is configured to translate the formal specification description into a representation on a theorem proof assistant which is defined and to be verified by using the library; and
a second theorem-proof-assistant description generating unit that is configured to translate a model and a temporal logic formula in the model checking description into a representation on the theorem proof assistant which is defined and to be verified by using the library.

2. The verification property integration apparatus according to claim 1,
wherein the first theorem-proof-assistant description generating unit uses coercion for a refinement relation contained in the formal specification description, generates an axiom indicating refinement, and handles a pre-condition, an invariant, or a post-condition which is a notion that does not exist on the theorem proof assistant, as a representation on semantics.

3. The verification property integration apparatus according to claim 1, wherein the second theorem-proof-assistant description generating unit is capable of selecting a type of a variable on the theorem proof assistant in accordance with mathematical strictness or ease of proof.

4. The verification property integration apparatus according to claim 1,
wherein the second theorem-proof-assistant description generating unit constructs a state of an entire system in model checking as a state of each individual process, a state of a communication channel, and a state of a variable, and defines a checking formula used in the model checking as a predicate on the theorem proof assistant.

5. The verification property integration apparatus according to claims 1,
wherein a description in Event-B is supplied to the first theorem-proof-assistant description generating unit;
a description in SPIN which is a model checker is supplied to the second theorem-proof-assistant description generating unit; and
the first theorem-proof-assistant description generating unit and the second theorem-proof-assistant description generating unit translate the supplied description into a description on a Coq theorem proof assistant.

6. The verification property integration apparatus according to claims 1,
wherein one or both of a description in Event-B and a description in VDM are supplied to the first theorem-proof-assistant description generating unit;
one or both of a description in SPIN and a description in UPPAAL are supplied to the second theorem-proof-assistant description generating unit; and
the first theorem-proof-assistant description generating unit and the second theorem-proof-assistant description generating unit translate the supplied description into a representation in any one of Coq, Isabelle, and PhoX which are theorem proof assistants.

7. A verification property integration method comprising:
translating a property defined and verified using a formal specification description and a model checking description into a description on a theorem proof assistant by
translating the formal specification description into a representation on the theorem proof assistant which is defined and to be verified by using a library which provides definition of semantics of the formal specification description and the model checking description which are to be provided to a theorem proof assistant description, and
translating a model and a temporal logic formula in the model checking description into a representation on the theorem proof assistant which is defined and to be verified by using the library.

8. The verification property integration method according to claim 7, further comprising:
using coercion for a refinement relation contained in a system definition in the formal specification description,
generating an axiom indicating refinement, and
handling a pre-condition, an invariant, or a post-condition which is a notion that does not exist on the theorem proof assistant, as a representation on semantics of the theorem proof assistant.

9. The verification property integration method according to claim 7, further comprising:
allowing to change a type of a variable on the theorem proof assistant according to mathematical strictness or ease of proof; and
constructing a state of an entire system in model checking by a state of each individual process, a state of a communication channel, and a state of a variable, and
defining a checking formula to be used in the model checking as a predicate on the theorem proof assistant.

10. A non-transitory computer readable storage medium in which a verification property integration program is recorded, the verification property integration program causing a computer to execute:
processing for translating a formal specification description into a representation on a theorem proof assistant which is defined and to be verified by using a library which provides definition of semantics of the formal specification description and a model checking description which are to be provided to a theorem-proof-assistant description; and
processing for translating a model and a temporal logic formula in the model checking description into a representation on the theorem proof assistant which is defined and to be verified by using the library.

11. The verification property integration apparatus according to claim 2,
wherein the first theorem-proof-assistant description generating unit
translates the refinement relation contained in the formal specification description into coercion, and
translates the pre-condition, the invariant, or the post-condition into an axiom on the theorem proof assistant.

12. The verification property integration method according to claim 8 further comprising:
translating the refinement relation contained in the formal specification description into coercion, and
translating the pre-condition, the invariant, or the post-condition into an axiom on the theorem proof assistant.
